(19) United States
(12) Patent Application Publication
(10) Pub. No.: US 2026/0141256 A1
(43) Pub. Date: May 21, 2026

(54) System and Method for Autonomous AI Red Teaming and Compliance Enforcement Using Adversarial Machine Learning

(71) Applicant: Sin Aik Ang, Sekinchan (MY)

(72) Inventor: Sin Aik Ang, Sekinchan (MY)

(21) Appl. No.: 19/185,171

(22) Filed: Apr. 21, 2025

Related U.S. Application Data
(60) Provisional application No. 63/721,681, filed on Nov. 18, 2024.

(51) Int. Cl. G06N 3/094; G06N 3/092

(52) U.S. Cl. CPC G06N 3/094; G06N 3/092

(57) ABSTRACT

A fully autonomous and unsupervised system for automated AI red teaming that utilizes generative adversarial networks (GANs), reinforcement learning (RL), and modular compliance logic to evaluate the robustness, reliability, and regulatory compliance of AI systems. The invention provides an adaptive adversarial testing engine that can simulate real-world attacks on AI models, log outcomes, generate audit reports, and assist in aligning model behavior with global AI governance standards such as ISO 42001, NIST AI RMF, and national AI certification frameworks. Designed for real-time and scalable deployment across diverse AI modalities, the system supports integration with vision, language, structured data, and multi-modal AI systems, and is designed for scalable deployment via API infrastructure. The invention is designed for scalable deployment in AI governance environments, including use in certification workflows, regulatory compliance assurance, and infrastructure protection across institutional and enterprise settings.

### FIELD OF THE INVENTION

The present invention relates generally to artificial intelligence (AI) security testing, and more particularly to systems and methods for automated adversarial testing (red teaming) of AI models using generative and reinforcement learning algorithms. The invention further relates to compliance monitoring, AI governance, and certification systems.

### BACKGROUND OF THE INVENTION

With the increasing integration of AI into mission-critical and public-facing systems, the need for robust security validation and regulatory compliance has become a national and global priority. Adversarial machine learning techniques have demonstrated the ability to manipulate or mislead AI models in ways that traditional testing fails to detect. While governance frameworks and compliance standards for AI continue to evolve, the gap between policy and practical enforcement tools remains unresolved.

While existing red teaming frameworks increasingly address software and cloud infrastructure vulnerabilities, they do not extend to the behavioral robustness and regulatory compliance of AI models. This invention uniquely targets AI-specific failure modes across modalities, offering domain-specific adversarial testing aligned with emerging AI governance standards.

Current solutions focus primarily on pre-defined or rule-based adversarial examples, which do not generalize well across models, domains, or threat scenarios. Furthermore, they lack scalable interfaces for integration with compliance frameworks or public-sector oversight infrastructures. There is a pressing need for an adaptive, autonomous, and standards-aligned red teaming tool that can operate across AI domains (vision, NLP, tabular, multi-modal) and support structured reporting for regulatory enforcement.

As artificial intelligence systems increase in autonomy and complexity, the need for scalable, machine-driven oversight becomes urgent. Human-in-the-loop approaches are no longer sufficient to ensure safety, robustness, and regulatory alignment. This has led to the emergence of the “AI governing AI” paradigm-where intelligent systems are tasked with monitoring, testing, and verifying the behavior of other AI systems. This invention addresses that gap by introducing a framework capable of autonomously stress-testing AI models, thus laying foundational groundwork for safety-aligned AI governance at scale.

The present invention provides improvements over conventional systems by enabling:
Adaptively optimize adversarial testing based on AI model feedback.
Integrate regulatory compliance logic during red teaming execution.
Support federated testing deployments without compromising data privacy.
Operate in a self-testing recursive loop for ongoing robustness.

### SUMMARY OF THE INVENTION

The present invention addresses the limitations of static and fragmented AI testing approaches by introducing an autonomous adversarial testing system. The system includes:
1. A GAN-based adaptive attack engine capable of generating real-world threat scenarios across domains.
2. A reinforcement learning controller that learns to optimize attack efficacy and surface new vulnerabilities.
3. A compliance logic module that evaluates model responses against predefined benchmarks and policy rules.
4. An audit engine that generates explainable security reports and tracks attack outcomes in a tamper-resistant format.
5. The system is adaptable for deployment through cloud-native APIs, SDKs, or browser-based agents depending on the external audit architecture,
6. A flexible architecture to support future model types, including LLMs, tabular AI, and multi-modal systems.

This invention represents a core step toward AI governing AI—an autonomous and unsupervised adversarial testing system that dynamically evaluates and challenges other AI models. The system operates without human intervention, learning from model responses and evolving attack strategies across time. It integrates not only technical red teaming but also compliance enforcement, thereby enabling AI systems to serve as governance engines for the safety, robustness, and policy alignment of other AI systems.

The system is designed for scalable deployment in AI security assurance environments, including applications in compliance testing, certification support, and regulatory auditing. Its modular design enables use in both enterprise and institutional (including public-sector) settings.

Beyond its technical contributions, the invention also represents a critical enabler of the broader vision of AI governing AI, particularly in preparation for the development and deployment of Artificial General Intelligence (AGI). By allowing AI systems to independently evaluate, challenge, and improve other AI systems, this red teaming framework advances the state of machine-accountable governance-providing the infrastructure for scalable, standards-aligned oversight without direct human supervision. Optional advanced embodiments further include real-time dynamic optimization and recursive self-testing capabilities, enhancing continuous adaptability and robustness

### DETAILED DESCRIPTION OF THE INVENTION

### Overview

The present invention provides an automated adversarial testing system comprising a modular architecture for AI red teaming. The system is designed to generate, optimize, and evaluate adversarial examples targeting AI models through a combination of generative adversarial networks (GANs) and reinforcement learning (RL). It further integrates compliance logic for policy-aware testing and structured audit reporting. The system may be deployed via API for integration into enterprise and public-sector workflows.

### System Architecture

### 1. Data Ingestion Module

Accepts structured or unstructured input datasets for red teaming.
Supports a wide range of input formats, including image, natural language text, structured tabular data, audio signals (e.g., voice waveforms or spectrograms), and multi-modal combinations thereof.
Enables real-time or batch data injection across modalities to support diverse red teaming use cases

### 2. GAN-Based Attack Generator

Generates adversarial examples dynamically in real-time or from batch inputs, leveraging both historical model training data and live inference queries, ensuring applicability in diverse operational contexts.
Incorporates latent vector sampling, input-domain constraints, and perturbation thresholds.
Supports real-time attack generation for live model interrogation or API-based testing pipelines.

### 3. Reinforcement Learning Controller

Receives feedback from model responses (e.g., confidence scores, output drift, misclassifications).
Dynamically tunes generator parameters in real-time based on immediate feedback from model responses, ensuring continuous and instantaneous adaptation of adversarial strategies.
Enables continuous adaptation based on performance metrics, supporting both batch learning and real-time online learning modes.

### 4. Defense Interaction & Monitoring Layer

Continuously monitors target AI model behavior and defensive responses during adversarial testing.
Provides immediate feedback loops to the reinforcement learning controller, enabling adaptive and dynamic optimization of adversarial strategies in real-time.

### 5. Compliance Logic Engine

Autonomously and continuously evaluates model outputs against real-time updated compliance benchmarks, policy rules, and governance standards without requiring manual updates or human intervention.
Flags violations and critical robustness gaps.

### 6. Audit & Reporting Engine

Autonomously generates structured, digitally signed, and tamper-proof audit reports that facilitate immediate regulatory or certification decisions, streamlining AI compliance processes.
Includes metadata such as attack class, model response, and policy flags.

### 7. Deployment Layer

The system includes a deployment interface configured to expose a RESTful API, SDK, browser extension, or other integration mechanism to facilitate incorporation into external audit systems, governance platforms, or certification workflows.
Supports deployment across public-sector, enterprise, and institutional AI governance and compliance workflows.
Enables federated deployment, allowing red teaming operations to be executed locally across a plurality of AI model nodes without requiring centralized access to sensitive data or models. Results from each node are aggregated in a privacy-preserving manner, aligning with regulatory frameworks such as GDPR, HIPAA, and ISO/IEC 42001.

### 8. Recursive Self-testing

In certain embodiments, the system includes a recursive self-testing capability, wherein it autonomously performs adversarial testing on instances of itself, allowing continuous self-improvement and adaptive robustness validation.

### Example Use Case: Red Teaming a Vision Classifier

Input: Labeled dataset of street signs.
Generator: Perturbs pixel values to induce misclassification.
RL Controller: Adjusts noise to maximize misclassification.
Compliance Module: Flags failure to meet robustness threshold.
Output: Attack vector+detailed report exported to auditor portal.

### Example Use Case: LLM Governance Evaluation

Input: Prompt sets testing toxicity, hallucination, and data leakage.
Generator: Crafts adversarial prompts.
RL Loop: Learns phrasing strategies that bypass safety filters.
Compliance Engine: Maps results to harmful output criteria.
Output: Signed red-teaming report for certification workflow.

### Example Use Case: Federated Model Certification and Tamper-Proof Logging

Scenario: Red teaming of federated fraud detection models across institutions.
Generator: Injects adaptive adversarial probes into remote model nodes.
RL Controller: Learns from cross-site feedback.
Compliance Module: Verifies fairness, robustness, and regulatory adherence.
Audit Engine: Logs signed results to a verifiable ledger.
Output: Certification summary with compliance status across nodes.

### Example Use Case: Post-Attack Calibration Reporting

Scenario: After adversarial red teaming is complete, the system compiles a vulnerability profile for the tested model.
Generator and RL Controller: Document adversarial examples and their impact.
Compliance Module: Scores severity of failure across robustness, fairness, or regulatory metrics.
Calibration Recommendation Engine: Suggests retraining or fine-tuning strategies based on observed weaknesses.
Audit Output: Calibration guidance report exported as part of the final certification pack.

### FIGURES AND CAPTIONS

FIG. 1 System-Level Architecture of the Autonomous AI Red Teaming Tool: A system-level flowchart illustrating the architecture of the AI red teaming tool, including modules for data ingestion, GAN-based adversarial generation, RL-based optimization, compliance logic, audit engine, and deployment APIs.

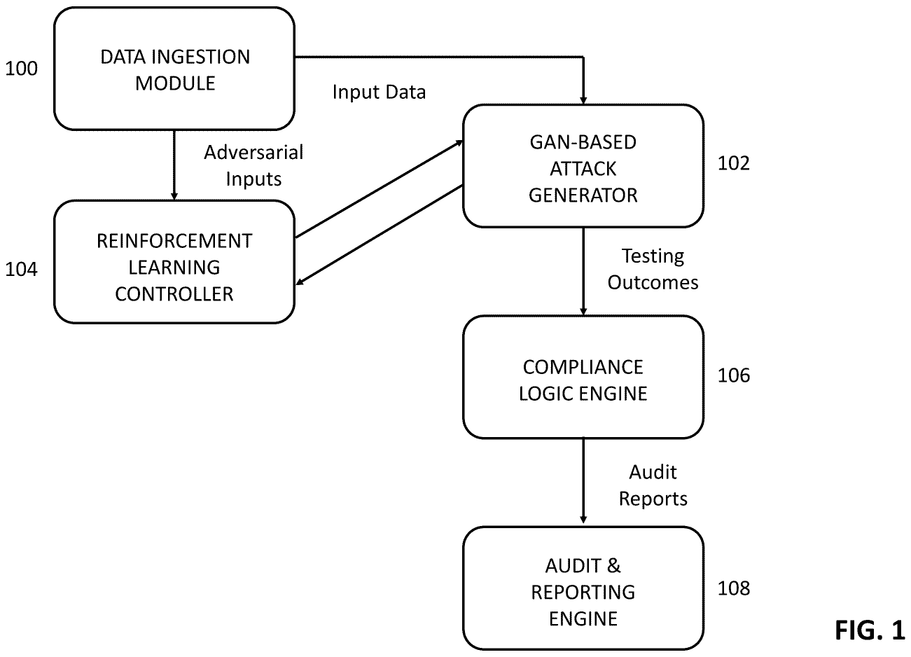

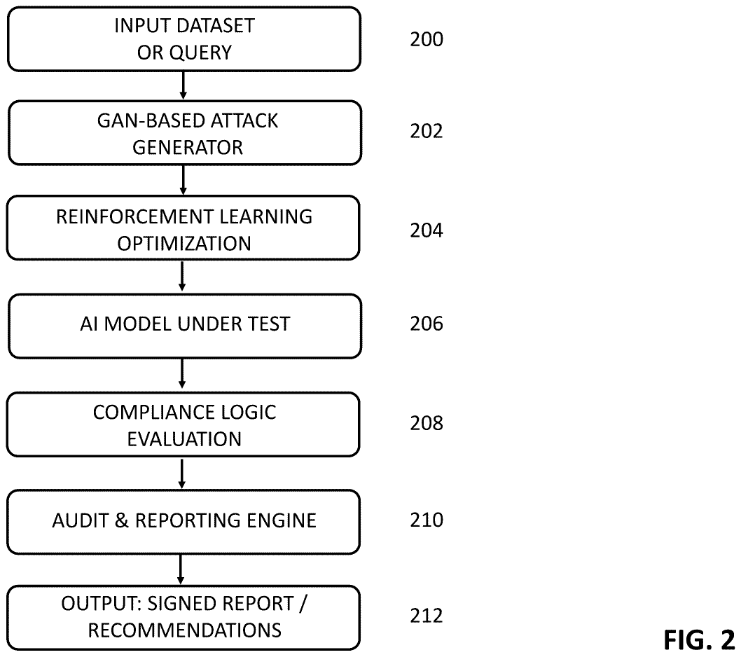

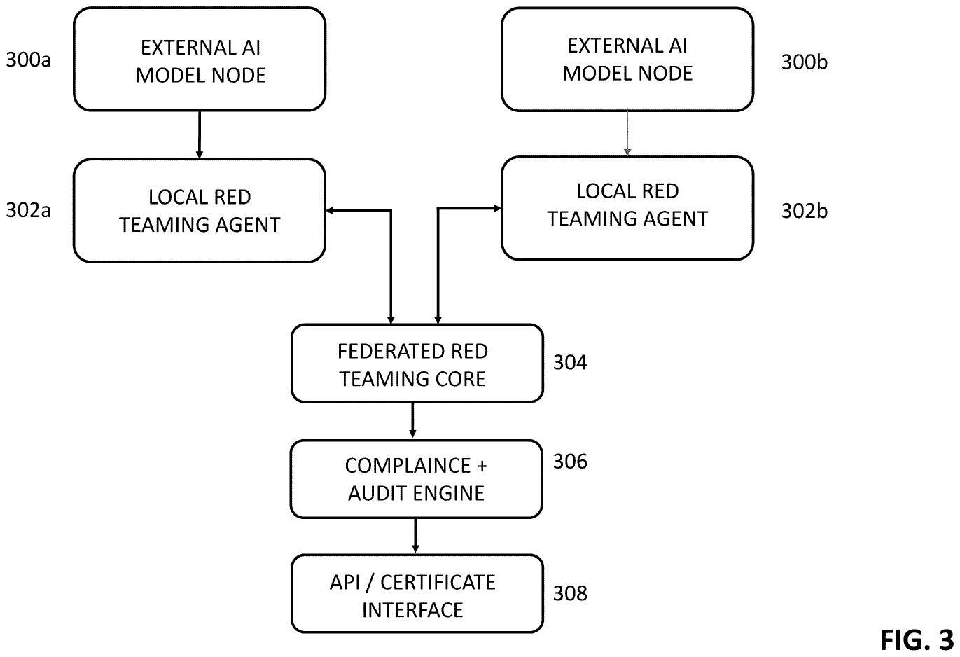

Referring now to FIG. 1, the system architecture comprises the following components:
100—Data Ingestion Module, responsible for supplying input data to both the GAN-based attack generator and the reinforcement learning controller.
102—GAN-Based Attack Generator, configured to generate adversarial input samples targeting an AI model under test. It receives input data from the ingestion module and dynamic strategy adjustments from the reinforcement learning controller.
104—Reinforcement Learning (RL) Controller, which dynamically adapts the attack generation strategy based on feedback from the GAN generator.
Note: A bidirectional feedback loop (two-way arrow) between 104 and 102 indicates that the RL Controller continuously refines attack generation based on performance feedback from the GAN-based attack outputs, and conversely influences future adversarial generation parameters.
106—Compliance Logic Engine, which analyzes the outcomes of adversarial tests against predefined benchmarks, including robustness, fairness, and regulatory conformance.
108—Audit and Reporting Engine, which compiles structured reports containing metrics and compliance observations derived from the compliance logic engine.

FIG. 2 End-to-End Red Teaming Workflow: A flowchart illustrating the sequential process of automated red teaming. It begins with input data or queries, followed by adversarial sample generation via a GAN-based engine, iterative optimization through reinforcement learning, and evaluation of the AI model's responses against compliance benchmarks. The results are compiled into structured audit reports for external review or certification.
200—Input Dataset or Query: Initial input data provided to the system for evaluation.
202—GAN-Based Attack Generator: Produces adversarial input samples designed to challenge the target AI model.
204—Reinforcement Learning Optimization: Dynamically adjusts the attack strategy based on model responses to improve effectiveness.
206—AI Model Under Test: The target model being evaluated for robustness and vulnerability.
208—Compliance Logic Evaluation: Assesses the model's behavior against regulatory, ethical, and performance benchmarks.
210—Audit & Reporting Engine: Aggregates test results and compliance data into structured outputs.
212—Output: Signed Report/Recommendations: The final output containing audit findings and actionable insights.

FIG. 3 Federated Red Teaming Deployment Architecture: The architecture illustrates a federated red teaming deployment that enables distributed adversarial testing across multiple external AI environments in a privacy-preserving manner. For illustration purposes, FIG. 3 depicts two representative external AI model environments (300a, 300b) and their associated local red teaming agents (302a, 302b). It should be understood that this architecture supports any number of external nodes, and the labeling is used solely to distinguish between instances. The system comprises the following components:
300a/300b—External AI Model Nodes, representing AI systems deployed by independent organizations such as banks, hospitals, or enterprises. These are the targets for red teaming, and are not accessible directly by the system operator.
302a /302b—Local Red Teaming Agents, deployed near or within each external model node's environment. These agents are responsible for running adversarial probes against the associated AI model locally, without transmitting raw model data externally. They act as edge agents or on-premise probes.
304—Federated Red Teaming Core, responsible for coordinating and aggregating red teaming results from multiple local agents. This core enables collaborative learning and attack refinement across sites without centralizing raw input/output data.
306—Compliance+Audit Engine, which analyzes the aggregated red teaming outcomes from the federated core against AI governance frameworks (e.g., ISO/IEC 42001, NIST AI RMF, national regulatory benchmarks), and identifies compliance violations or robustness gaps.
308—API/Certification Interface, configured to expose the final audit outputs to external systems such as certification bodies, compliance platforms, or enterprise governance dashboards. May support RESTful APIs, SDKs, or secure web interfaces.

### ADVANTAGES OF THE INVENTION

Fully autonomous and scalable across enterprise/public-sector use cases.
Real-time compliance enforcement integrated with attack execution.
Alignment with emerging AI safety standards and certifications.
Modular design compatible with multi-modal AI systems.
Enables AI to govern AI in real-world oversight environments.

1: A system for automated red teaming of artificial intelligence (AI) models, comprising: (a) a generative adversarial network (GAN)-based attack generator configured to produce adversarial input samples targeting at least one AI model; (b) a reinforcement learning (RL) controller configured to adapt the behavior of the attack generator based on feedback from responses of the AI model to the adversarial input samples; (c) a compliance logic module configured to evaluate the responses of the AI model against predefined compliance benchmarks; and (d) an audit module configured to generate structured reports comprising results of the adversarial testing, including metrics of robustness and compliance violations.

2: A method of performing automated red teaming of an AI model, the method comprising: (a) generating a set of adversarial samples using a GAN; (b) applying the adversarial samples to the AI model; (c) receiving feedback from the AI model and optimizing further adversarial samples using RL; (d) evaluating the responses of the AI model against one or more compliance standards; and (e) outputting an audit report comprising vulnerability metrics and compliance flags. Dependent Claims

3: The system of claim 1, wherein the GAN-based attack generator is configured to operate across multiple input types including image, text, tabular data, and multi-modal data.

4: The system of claim 1, wherein the RL controller utilizes a reward function that maximizes adversarial success while minimizing perturbation cost.

5: The system of claim 1, further comprising a deployment interface configured to expose a RESTful API, software development kit (SDK), browser extension, or other integration mechanism for connection with external audit pipelines or certification workflows.

6: The system of claim 1, wherein the compliance logic module includes mapping logic aligned with one or more of: (i) ISO/IEC 42001; (ii) the NIST AI Risk Management Framework; (iii) national or sectoral AI regulatory certification benchmarks; or (iv) any future-developed international, public-sector, or industry-specific AI governance standards.

7: The system of claim 1, further comprising a federated deployment layer configured to execute red teaming operations across a plurality of AI model nodes in a privacy-preserving manner.

8: The system of claim 1, wherein the audit module includes a tamper-proof logging engine that digitally signs or encrypts audit data to ensure integrity.

9: The system of claim 1, further comprising a post-attack reporting module configured to generate calibration recommendations or retraining directives based on adversarial test outcomes.

10: The system of claim 1, wherein the adversarial attack generation and reinforcement learning controller operate in real-time, dynamically optimizing adversarial strategies based on immediate feedback from the target AI model.

11: The system of claim 1, wherein the adversarial testing includes a recursive self-testing mode for evaluating and improving the robustness and adaptability of the red-teaming system itself.

12: The method of claim 2, wherein evaluating the responses includes assessing robustness under adversarial perturbations, model accuracy drops, fairness deviation, or policy violations.

13: The method of claim 2, further comprising the step of identifying transferable adversarial strategies that are effective across multiple AI models with different architectures.
